(19) United States
(12) Patent Application Publication
(10) Pub. No.: US 2010/0149096 A1
(43) Pub. Date: Jun. 17, 2010

(54) NETWORK MANAGEMENT USING INTERACTION WITH DISPLAY SURFACE

(76) Inventors: Charles J. Migos, San Francisco, CA (US); Nadav M. Neufeld, Sunnyvale, CA (US); Gionata Mettifogo, Menlo Park, CA (US); Afshan A. Kleinhanzl, San Francisco, CA (US)

Correspondence Address: VIERRA MAGEN/MICROSOFT CORPORATION, 575 MARKET STREET, SUITE 2500, SAN FRANCISCO, CA, 94105, US

(21) Appl. No.: 12/337,465

(22) Filed: Dec. 17, 2008

(51) Int. Cl. G09G 5/08

(52) U.S. Cl. 345/158

(57) ABSTRACT

A computing system is provided to make managing the devices and content on a network easier by making the process intuitive, tactile and gestural. The computing system includes a display surface for graphically displaying the devices connected to a network and the content stored on those devices. A sensor is used to recognize activity on the display surface so that gestures may be used to control a device on the network and transport data between devices on the network. Additionally, new devices can be provided access to communicate on the network based on interaction with the display device.

### BACKGROUND

Local area networks have become cheaper and easier to deploy. Thus, many people have deployed home networks. Concurrent with the rise in use of home networks, many more devices have become network ready. For example, telephones, digital cameras, televisions (with set top boxes) and other devices can now communicate on a home network. With the proliferation of network-ready devices and the large amount of content available, it has become difficult to manage the devices and content on the network using the traditional computer-based tools.

### SUMMARY

A computing system is provided to make managing the devices and content on the network easier by making the process intuitive, tactile and gestural. The computing system includes a display surface for graphically displaying the devices connected to a network and the content stored on those devices. A sensor is used to recognize activity on the display surface so that gestures may be used to control a device on the network and transport data between devices on the network. Additionally, new devices can be provided access to communicate on the network based on interaction with the display device.

One embodiment includes displaying on a display surface of a first device images representing a set of devices that can communicate on a network, automatically sensing an object adjacent to the display surface, automatically determining that a first type of gesture of a plurality of types of gestures is being performed by the object, identifying a command associated with the first type of gesture, generating a communication and sending the communication from the first device to a target device via the network to cause the target device to perform the command. The target device is different than the first device. The set of devices that can communicate on the network includes the target device.

One embodiment includes displaying on a display surface of a first device images representing a set of devices that can communicate on a network, automatically sensing an object adjacent to the display surface, automatically determining that a first type of gesture of a plurality of types of gestures is being performed by the object, identifying a command associated with the first type of gesture, and generating a communication and sending the communication from the first device to at least one of a set of selected devices via the network. The communication includes information to cause the selected devices to implement a data relationship that includes repeated transfer of data based on a set of one or more rules associated with the data relationship. Examples of the data relationship includes one way synchronization, two way synchronization, backing-up data, etc.

One example implementation includes one or more processors, one or more storage devices in communication with the one or more processors, a network interface in communication with the one or more processors, a display surface in communication with the one or more processors, and a sensor in communication with the one or more processors. The sensor senses data indicating presence of a communication device on the display surface that is not directly connected to the network. The one or more processors recognize the communication device on the display surface that is not directly connected to the network, determine how to communicate with the communication device on the display surface, and relay data between the communication device on the display surface (which is not directly connected to the network) and at least one other device on the network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a computing system with an interactive display device.

FIG. 2 is a cut-away side view of a computing system with an interactive display device.

FIG. 3 depicts an example of a computing system with an interactive display device.

FIGS. 4A-4D depicts a portion of a display surface and the data detected by a sensor.

FIG. 5 is a block diagram depicting the physical connections of a set of computing devices on a network.

FIG. 6 is a flow chart describing one embodiment of a process for managing the devices connected to a network.

FIG. 7 is a display surface depicting the devices on a network.

FIG. 8 is a display surface depicting the devices on a network and a subset of content on one of the devices.

FIG. 9 is a flow chart describing one embodiment of a process for transporting or playing content using gestures.

FIG. 10 is a flow chart describing one embodiment of a process for controlling a device on the network using gestures.

FIG. 11 is a display surface depicting the devices on a network and data relationships between a subset of the devices.

FIG. 12 is a flow chart describing one embodiment of a process for creating data relationships between devices on a network using gestures.

FIG. 13 is a flow chart describing one embodiment of a process for creating data relationships between devices on a network using gestures.

FIG. 14 is a flow chart describing one embodiment of a process for managing data relationships between devices on a network using gestures.

FIG. 15 is a display surface depicting the devices on a network.

FIG. 16 is a display surface depicting the devices on a network and a new devices that is being provided with the ability to communicate with devices on the network.

FIG. 17 is a flow chart describing one embodiment of a process for providing a new device, not directly connected to the network, with the ability to communicate with devices on the network.

FIG. 18 is a block diagram depicting the physical connections of a set of computing devices that can communicate with each other.

FIG. 19 is a flow chart describing one embodiment of a process for providing a new device, not directly connected to the network, with the ability to communicate with devices on the network.

FIG. 20 is a flow chart describing one embodiment of a process for providing a new device, not directly connected to the network, with the ability to communicate with devices on the network.

### DETAILED DESCRIPTION

A computing system is provided to make managing devices and content on a network easier by making the process intuitive, tactile and gestural. The computing system described herein includes an interactive display surface that is used to graphically display the devices and content on the network. The computing system further includes a sensor system that is used to detect and recognize activity on the display surface. For example, hand gestures of a person's hand (or other body part) adjacent the display surface and placement of a computing device adjacent the display surface can be recognized. In response to the recognized activity, the computing system can cause functions to be performed on other computing devices connected to the network, transfer content between computing devices on the network, and provide for new devices not directly connected to the network to be placed adjacent the display surface and then enabled to communicate with other computing devices on the network.

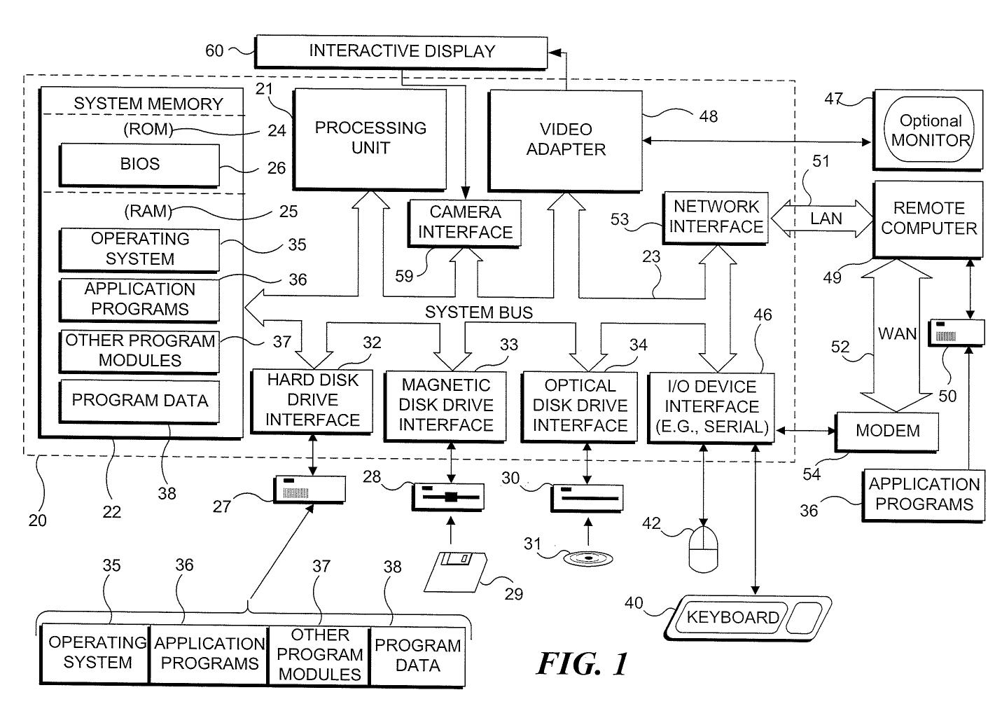

FIG. 1 depicts one example of a suitable computing system 20 with an interactive display 60 for managing devices and content on a network. Computing system 20 includes a processing unit 21, a system memory 22, and a system bus 23. The system bus couples various system components including the system memory to processing unit 21 and may be any of several types of bus structures, including a memory bus or memory controller, a peripheral bus, and a local bus using any of a variety of bus architectures. Processing unit 21 includes one or more processors. The system memory includes read only memory (ROM) 24 and random access memory (RAM) 25. A basic input/output system (BIOS) 26, containing the basic routines that help to transfer information between elements within the Computing system 20, such as during start up, is stored in ROM 24. Computing system 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31, such as a compact disk-read only memory (CD-ROM) or other optical media. Hard disk drive 27, magnetic disk drive 28, and optical disk drive 30 are connected to system bus 23 by a hard disk drive interface 32, a magnetic disk drive interface 33, and an optical disk drive interface 34, respectively. The drives and their associated computer readable media provide nonvolatile storage of computer readable machine instructions, data structures, program modules, and other data for computing system 20. Although the exemplary environment described herein employs a hard disk, removable magnetic disk 29, and removable optical disk 31, it will be appreciated by those skilled in the art that other types of computer readable media, which can store data and machine instructions that are accessible by a computer, such as magnetic cassettes, flash memory cards, digital video disks (DVDs), Bernoulli cartridges, RAMs, ROMs, and the like, may also be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. These program modules are used to program the one or more processors of computing system 20 to perform the processes described herein. A user may enter commands and information in computing system 20 and provide control input through input devices, such as a keyboard 40 and a pointing device 42. Pointing device 42 may include a mouse, stylus, wireless remote control, or other pointer, but in connection with the present invention, such conventional pointing devices may be omitted, since the user can employ the interactive display for input and control. As used hereinafter, the term “mouse” is intended to encompass virtually any pointing device that is useful for controlling the position of a cursor on the screen. Other input devices (not shown) may include a microphone, joystick, haptic joystick, yoke, foot pedals, game pad, satellite dish, scanner, or the like. These and other input/output (I/O) devices are often connected to processing unit 21 through an I/O interface 46 that is coupled to the system bus 23. The term I/O interface is intended to encompass each interface specifically used for a serial port, a parallel port, a game port, a keyboard port, and/or a universal serial bus (USB).

System bus 23 is also connected to a camera interface 59 and video adaptor 48. Camera interface 59 is coupled to interactive display 60 to receive signals from a digital video camera (or other sensor) that is included therein, as discussed below. The digital video camera may be instead coupled to an appropriate serial I/O port, such as to a USB port. Video adaptor 58 is coupled to interactive display 60 to send signals to a projection and/or display system.

Optionally, a monitor 47 can be connected to system bus 23 via an appropriate interface, such as a video adapter 48; however, the interactive display of the present invention can provide a much richer display and interact with the user for input of information and control of software applications and is therefore preferably coupled to the video adaptor. It will be appreciated that computers are often coupled to other peripheral output devices (not shown), such as speakers (through a sound card or other audio interface—not shown) and printers.

The present invention may be practiced on a single machine, although computing system 20 can also operate in a networked environment using logical connections to one or more remote computers, such as a remote computer 49. Remote computer 49 may be another PC, a server (which is typically generally configured much like computing system 20), a router, a network PC, a peer device, or a satellite or other common network node, and typically includes many or all of the elements described above in connection with computing system 20, although only an external memory storage device 50 has been illustrated in FIG. 1. The logical connections depicted in FIG. 1 include a local area network (LAN) 51 and a wide area network (WAN) 52. Such networking environments are common in offices, enterprise wide computer networks, intranets, and the Internet.

When used in a LAN networking environment, computing system 20 is connected to LAN 51 through a network interface or adapter 53. When used in a WAN networking environment, computing system 20 typically includes a modem 54, or other means such as a cable modem, Digital Subscriber Line (DSL) interface, or an Integrated Service Digital Network (ISDN) interface for establishing communications over WAN 52, such as the Internet. Modem 54, which may be internal or external, is connected to the system bus 23 or coupled to the bus via I/O device interface 46, i.e., through a serial port. In a networked environment, program modules, or portions thereof, used by computing system 20 may be stored in the remote memory storage device. It will be appreciated that the network connections shown are exemplary and other means of establishing a communications link between the computers may be used, such as wireless communication and wide band network links.

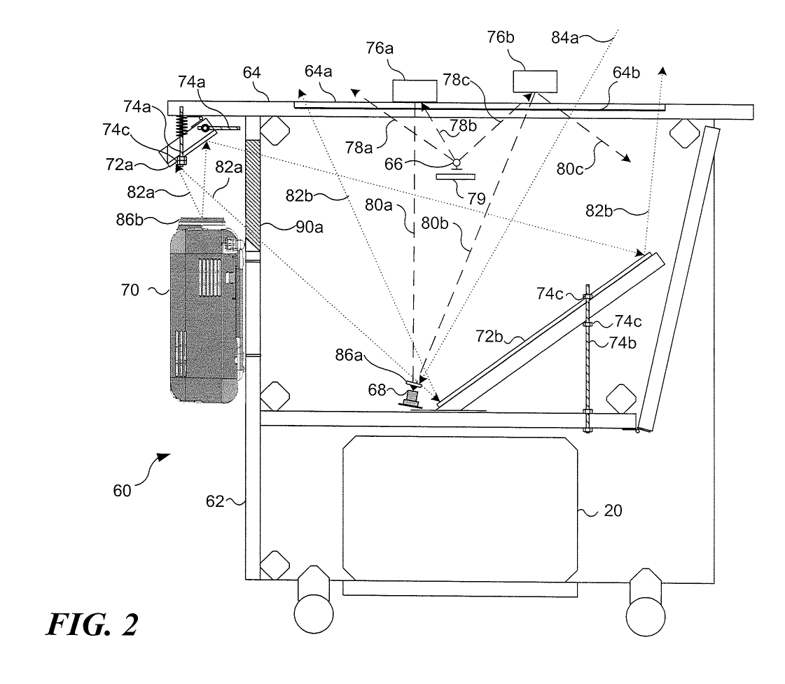

FIG. 2 provides additional details of an exemplary interactive display 60, which is implemented as part of a display table that includes computing system 20 within a frame 62 and which serves as both an optical input and video display device for computing system 20. In this cut-away drawing of the interactive display table, rays of light used for displaying text and graphic images are generally illustrated using dotted lines, while rays of infrared (IR) light used for sensing objects adjacent to (e.g., on or just above) display surface 64a of the interactive display table are illustrated using dash lines. Display surface 64a is set within an upper surface 64 of the interactive display table. The perimeter of the table surface is useful for supporting a user's arms or other objects, including objects that may be used to interact with the graphic images or virtual environment being displayed on display surface 64a.

IR light sources 66 preferably comprise a plurality of IR light emitting diodes (LEDs) and are mounted on the interior side of frame 62. The IR light that is produced by IR light sources 66 is directed upwardly toward the underside of display surface 64a, as indicated by dash lines 78a, 78b, and 78c. The IR light from IR light sources 66 is reflected from any objects that are atop or proximate to the display surface after passing through a translucent layer 64b of the table, comprising a sheet of vellum or other suitable translucent material with light diffusing properties. Although only one IR source 66 is shown, it will be appreciated that a plurality of such IR sources may be mounted at spaced apart locations around the interior sides of frame 62 to prove an even illumination of display surface 64a. The infrared light produced by the IR sources may exit through the table surface without illuminating any objects, as indicated by dash line 78a or may illuminate objects adjacent to the display surface 64a. Illuminating objects adjacent to the display surface 64a include illuminating objects on the table surface, as indicated by dash line 78b, or illuminating objects a short distance above the table surface but not touching the table surface, as indicated by dash line 78c.

Objects adjacent to display surface 64a include a “touch” object 76a that rests atop the display surface and a “hover” object 76b that is close to but not in actual contact with the display surface. As a result of using translucent layer 64b under the display surface to diffuse the IR light passing through the display surface, as an object approaches the top of display surface 64a, the amount of IR light that is reflected by the object increases to a maximum level that is achieved when the object is actually in contact with the display surface.

A digital video camera 68 is mounted to frame 62 below display surface 64a in a position appropriate to receive IR light that is reflected from any touch object or hover object disposed above display surface 64a. Digital video camera 68 is equipped with an IR pass filter 86a that transmits only IR light and blocks ambient visible light traveling through display surface 64a along dotted line 84a. A baffle 79 is disposed between IR source 66 and the digital video camera to prevent IR light that is directly emitted from the IR source from entering the digital video camera, since it is preferable that this digital video camera should produce an output signal that is only responsive to the IR light reflected from objects that are a short distance above or in contact with display surface 64a and corresponds to an image of IR light reflected from objects on or above the display surface. It will be apparent that digital video camera 68 will also respond to any IR light included in the ambient light that passes through display surface 64a from above and into the interior of the interactive display (e.g., ambient IR light that also travels along the path indicated by dotted line 84a).

IR light reflected from objects on or above the table surface may be: reflected back through translucent layer 64b, through IR pass filter 86a and into the lens of digital video camera 68, as indicated by dash lines 80a and 80b; or reflected or absorbed by other interior surfaces within the interactive display without entering the lens of digital video camera 68, as indicated by dash line 80c.

Translucent layer 64b diffuses both incident and reflected IR light. Thus, as explained above, “hover” objects that are closer to display surface 64a will reflect more IR light back to digital video camera 68 than objects of the same reflectivity that are farther away from the display surface. Digital video camera 68 senses the IR light reflected from “touch” and “hover” objects within its imaging field and produces a digital signal corresponding to images of the reflected IR light that is input to computing system 20 for processing to determine a location of each such object, and optionally, the size, orientation, and shape of the object. It should be noted that a portion of an object (such as a user's forearm) may be above the table while another portion (such as the user's finger) is in contact with the display surface. In addition, an object may include an IR light reflective pattern or coded identifier (e.g., a bar code) on its bottom surface that is specific to that object or to a class of related objects of which that object is a member. Accordingly, the imaging signal from digital video camera 68 can also be used for detecting each such specific object, as well as determining its orientation, based on the IR light reflected from its reflective pattern, or based upon the shape of the object evident in the image of the reflected IR light, in accord with the present invention. The logical steps implemented to carry out this function are explained below.

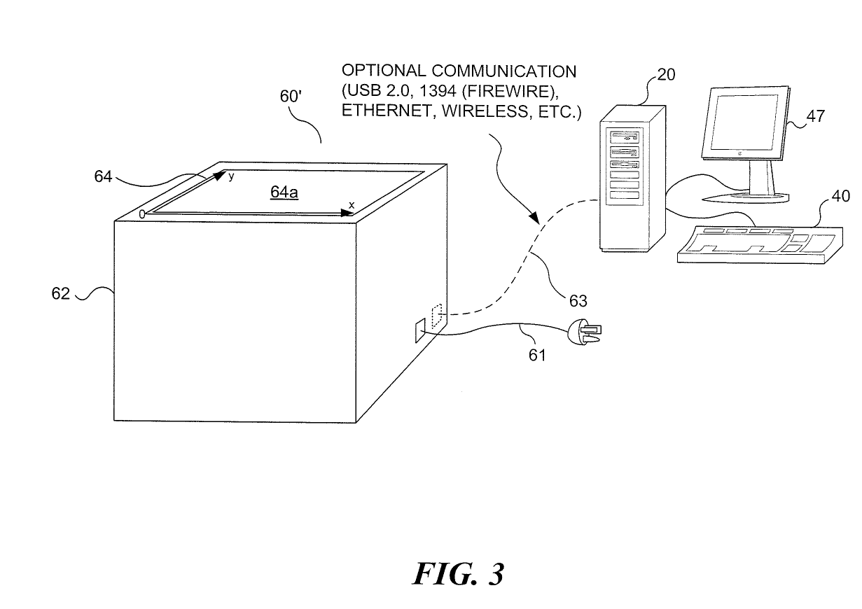

Computing system 20 may be integral to interactive display table 60 as shown in FIG. 2, or alternatively, may instead be external to the interactive display table, as shown in the embodiment of FIG. 3. In FIG. 3, an interactive display table 60′ is connected through a data cable 63 to an external computing system 20 (which includes optional monitor 47, as mentioned above). As also shown in this figure, a set of orthogonal X and Y axes are associated with display surface 64a, as well as an origin indicated by “0.” While not discretely shown, it will be appreciated that a plurality of coordinate locations along each orthogonal axis can be employed to specify any location on display surface 64a.

If the interactive display table is connected to an external computing system 20 (as in FIG. 3) or to some other type of external computing device, such as a set top box, video game, laptop computer, or media computer (not shown), then the interactive display table comprises an input/output device. Power for the interactive display table is provided through a power cable 61, which is coupled to a conventional alternating current (AC) source (not shown). Data cable 63, which connects to interactive display table 60′, can be coupled to a USB port, an Institute of Electrical and Electronics Engineers (IEEE) 1394 (or Firewire) port, or an Ethernet port on computing system 20. It is also contemplated that as the speed of wireless connections continues to improve, the interactive display table might also be connected to a computing device such as computing system 20 via a high speed wireless connection, or via some other appropriate wired or wireless data communication link. Whether included internally as an integral part of the interactive display, or externally, computing system 20 executes algorithms for processing the digital images from digital video camera 68 and executes software applications that are designed to use the more intuitive user interface functionality of interactive display table 60 to good advantage, as well as executing other software applications that are not specifically designed to make use of such functionality, but can still make good use of the input and output capability of the interactive display table. As yet a further alternative, the interactive display can be coupled to an external computing device, but include an internal computing device for doing image processing and other tasks that would then not be done by the external PC.

An important and powerful feature of the interactive display table (i.e., of either embodiments discussed above) is its ability to display graphic images or a virtual environment for games or other software applications and to enable an interaction between the graphic image or virtual environment visible on display surface 64a and identify objects that are resting atop the display surface, such as a object 76a, or are hovering just above it, such as a object 76b.

Referring to FIG. 2, interactive display table 60 includes a video projector 70 that is used to display graphic images, a virtual environment, or text information on display surface 64a. The video projector is preferably of a liquid crystal display (LCD) or digital light processor (DLP) type, or a liquid crystal on silicon (LCOS) display type, with a resolution of at least 640×480 pixels (or more). An IR cut filter 86b is mounted in front of the projector lens of video projector 70 to prevent IR light emitted by the video projector from entering the interior of the interactive display table where the IR light might interfere with the IR light reflected from object(s) on or above display surface 64a. A first mirror assembly 72a directs projected light traveling from the projector lens along dotted path 82a through a transparent opening 90a in frame 62, so that the projected light is incident on a second mirror assembly 72b. Second mirror assembly 72b reflects the projected light onto translucent layer 64b, which is at the focal point of the projector lens, so that the projected image is visible and in focus on display surface 64a for viewing.

Alignment devices 74a and 74b are provided and include threaded rods and rotatable adjustment nuts 74c for adjusting the angles of the first and second mirror assemblies to ensure that the image projected onto the display surface is aligned with the display surface. In addition to directing the projected image in a desired direction, the use of these two mirror assemblies provides a longer path between projector 70 and translucent layer 64b, and more importantly, helps in achieving a desired size and shape of the interactive display table, so that the interactive display table is not too large and is sized and shaped so as to enable the user to sit comfortably next to it.

Objects that are adjacent to (e.g., on or near) displays surface are sensed by detecting the pixels comprising a connected component in the image produced by IR video camera 68, in response to reflected IR light from the objects that is above a predefined intensity level. To comprise a connected component, the pixels must be adjacent to other pixels that are also above the predefined intensity level. Different predefined threshold intensity levels can be defined for hover objects, which are proximate to but not in contact with the display surface, and touch objects, which are in actual contact with the display surface. Thus, there can be hover connected components and touch connected components. Details of the logic involved in identifying objects, their size, and orientation based upon processing the reflected IR light from the objects to determine connected components are set forth in United States Patent Application Publications 2005/0226505 and 2006/0010400, both of which are incorporated herein by reference in their entirety.

As a user moves one or more fingers of the same hand across the display surface of the interactive table, with the fingers tips touching the display surface, both touch and hover connected components are sensed by the IR video camera of the interactive display table. The finger tips are recognized as touch objects, while the portion of the hand, wrist, and forearm that are sufficiently close to the display surface, are identified as hover object(s). The relative size, orientation, and location of the connected components comprising the pixels disposed in these areas of the display surface comprising the sensed touch and hover components can be used to infer the position and orientation of a user's hand and digits (i.e., fingers and/or thumb). As used herein and in the claims that follow, the term “finger” and its plural form “fingers” are broadly intended to encompass both finger(s) and thumb(s), unless the use of these words indicates that “thumb” or “thumbs” are separately being considered in a specific context.

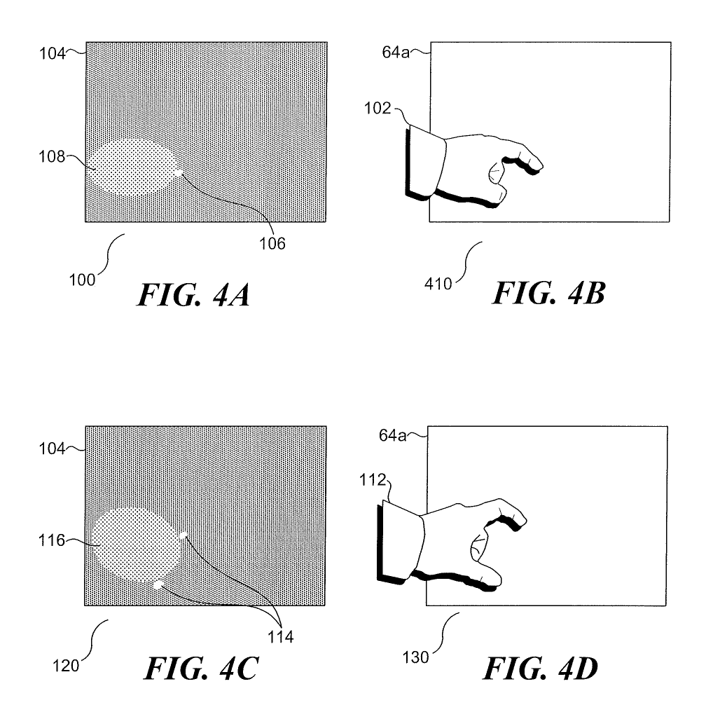

In FIG. 4A, an illustration 400 shows, in an exemplary manner, a sensed input image 404. Note that the image is sensed through the diffusing layer of the display surface. The input image comprises a touch connected component 406 and a hover connected component 408. In FIG. 4B, an illustration 410 shows, in an exemplary manner, an inferred hand 402 above the display surface that corresponds to hover connected component 408 in FIG. 4A. The index finger of the inferred hand is extended and the tip of the finger is in physical contact with the display surface whereas the remainder of the finger and hand is not touching the display surface. The finger tip that is in contact with the display surface thus corresponds to touch connected component 406.

Similarly, in FIG. 4C, an illustration 420 shows, in an exemplary manner, a sensed input image 404. Again, the image of the objects above and in contact with the display surface is sensed through the diffusing layer of the display surface. The input image comprises two touch connected components 414, and a hover connected component 416. In FIG. 4D, an illustration 430 shows, in an exemplary manner, an inferred hand 412 above the display surface. The index finger and the thumb of the inferred hand are extended and in physical contact with the display surface, thereby corresponding to touch connected components 414, whereas the remainder of the fingers and the hand are not touching the display surface and therefore correspond to hover connected component 416.

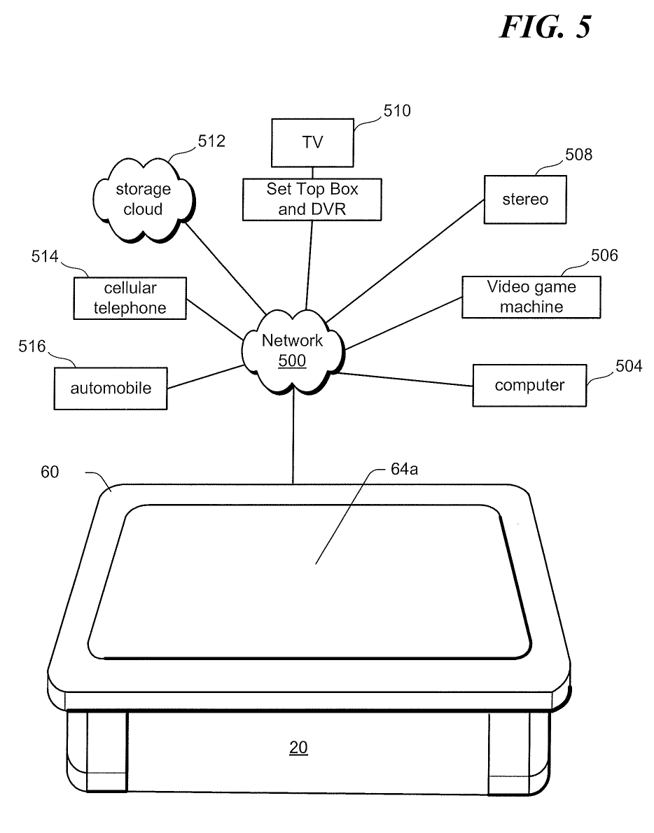

FIG. 5 is a block diagram depicting the physical connections of multiple devices that can communicate with each other, including computing device 20 with interactive display 20. For example, FIG. 5 shows computing device 20 with interactive display 60 in communication with network 500. In one embodiment, network 500 is a local area network. FIG. 5 also shows other devices connected to network 500 including computer 504, video game machine 506, stereo 508, television system 510, storage cloud 512, cellular telephone 514 and automobile 516. In one embodiment, each of the devices 504-516 can be connected to the network via a wired connection or wireless connection. Computer 504 can be a desktop computer, notebook computer or any other computing device. Video game machine 506 can be a computing device specially designed to play video games. Stereo system 508 includes one or more electronic components that play audio, including digital audio files. Television system 510 includes a television, set top box, and digital video recorder (DVR). Storage cloud 512 is a system for storing large amounts of data and is managed by a third party. The user contracts with a third party to store the user's data. The third party manages the storage system without the user necessarily needing to know about details of the structure and/or architecture of the storage system. Cellular telephone 514 can be a standard cellular telephone that may or may not include WiFi capability. Automobile 516 includes a wired or wireless connection to network 500 for communicating media files and other data.

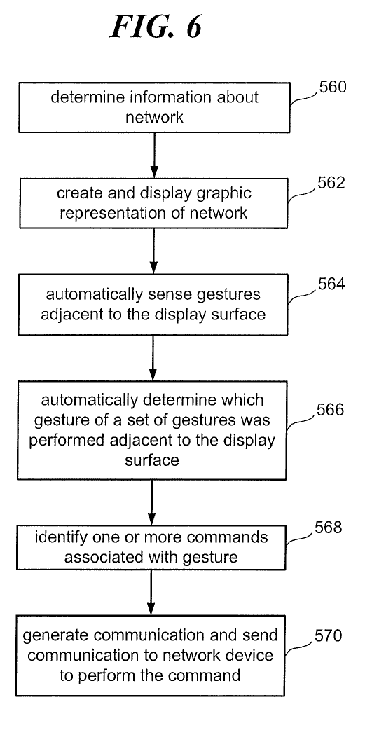

Using gestures made adjacent to display surface 64a, computing system 20 can be used to manage all or a subset of the devices connected to network 500. FIG. 6 is a flow chart describing one embodiment of a process for managing the devices connected to network 500. In step 560, computing system 20 determines information about network 500, including what devices are connected to the network. The process of discovering what devices are connected to the network can be done automatically or can be done manually by having a user provide configuration information. In step 562, computing device 20 and interactive display 60 will automatically create and display a graphic representation of the network on display surface 64a. The graphic representation of the network will include images associated with each of the devices connected to the network.

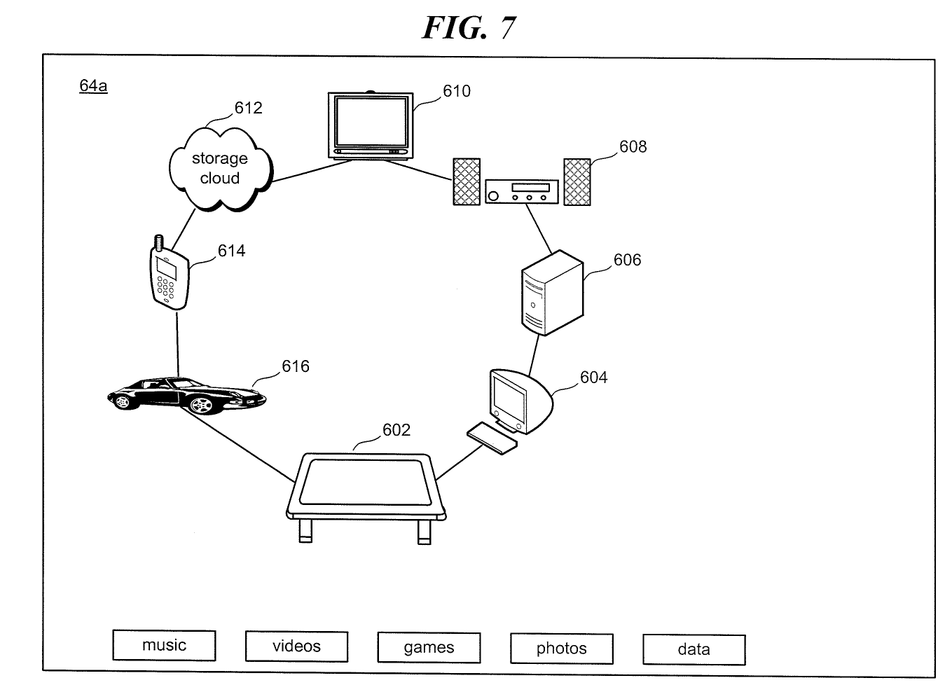

FIG. 7 provides one embodiment of a graphical representation of the network. For example, FIG. 7 shows display surface 64a depicting computing device 20 with interactive display 60 depicted as icon 602. Computer 504 is depicted as icon 604. Video game 506 is depicted as icon 606. Stereo system 508 is depicted as icon 608. Television system 510 is depicted as icon 610. Storage cloud 512 is depicted as icon 612. Cellular telephone 514 is depicted as icon 614. Automobile 516 is depicted as icon 616. In one embodiment, the user can touch any of the appropriate icons using one or more gestures and then use additional gestures to cause a function to be performed for the device associated with the icon selected.

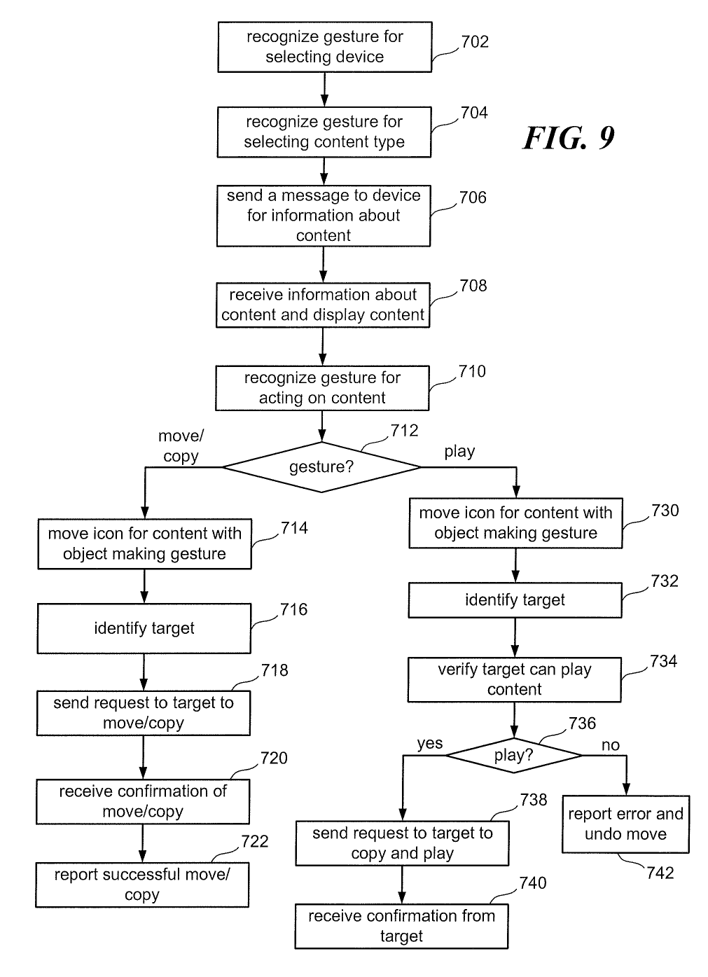

A user can request that a task be performed by making a predetermined gesture with the user's hand or other body part adjacent to display surface 64a. Interactive display 60 will automatically sense the gesture in step 564 of FIG. 6. In step 566, computing device 20 will automatically determine which type of gesture of a set of known types of gestures (see below) was performed by the hand or other body part (or other type of object). In step 568, computing device 20 automatically identifies a command associated with the gesture. In step 570, computing device 20 will automatically generate and send a message via network 500 to another device on the network to perform the command. FIGS. 9, 10, 12, 13, and 14 provide more details of various example embodiments of steps 564-570 of FIG. 6.

An example list (but not exhaustive) of types of gestures that can be used include tapping a finger, tapping multiple fingers, tapping a palm, tapping an entire hand, tapping an arm, multiple taps, rotating a hand, flipping a hand, sliding a hand and/or arm, throwing motion, spreading out fingers or other parts of the body, squeezing in fingers or other parts of the body, using two hands to perform any of the above, drawing letters, drawing numbers, drawing symbols, performing any of the above gestures using different speeds, performing multiple gestures concurrently, and holding down a hand or body part for a prolonged period of time. The system can use any of the above-described gestures (as well as other gestures) to manage the devices connected to the network. For example, the gestures can be used to transfer data, play content on a specific device, run an application on a specific device, manage relationships between devices, add devices to a network, remove devices from a network, or other functions.

In one example, a user can move data (e.g., including content such as music, videos, games, photos, or other data) from one device on the network to another device on the network. In other examples, a user can cause content in one device to be played on another device. In one embodiment, a user will select one of the devices 602-616 as a source of data/content to be transferred or played. That device will be selected using any of the gestures described above (or other gestures). Additionally, the user will select a type of content. For example, FIG. 7 shows five buttons (music, videos, games, photos, data). The user can select any of the five buttons using a predetermined one of the gestures described above (or other gestures). Once a device has been selected and a particular set of one or more types of content, the content on the device that pertains to the selected button will be depicted on display surface 64a.

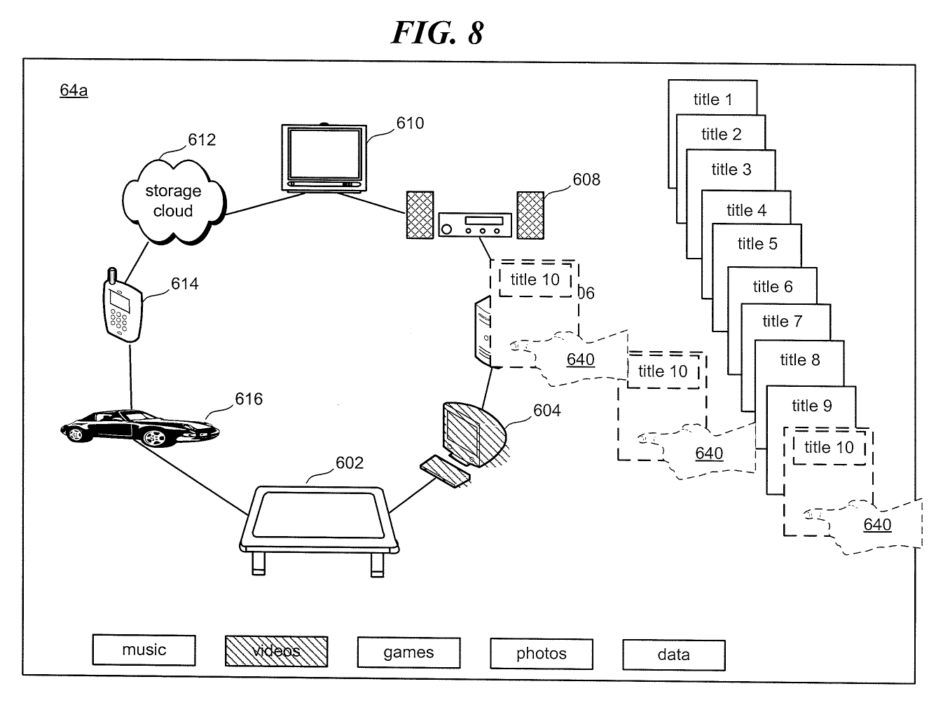

For example, FIG. 8 shows computer 604 as selected (shading indicates selection) and videos button being selected (shading indicates selection). In response to those two selections, all the videos being stored on computer 604 are graphically depicted on display surface 64a using a set of icons. For example, FIG. 8 shows icons for Title 1-Title 10. In one embodiment, each icon can include a title of the video. Additionally, depending on the implementation, the icon may also include other information such as genre, actors, synopsis and a preview. By the user selecting the preview in the icon, a video of the preview will be provided to the user. The user can use gestures to stop, rewind, fast-forward or pause the video. With other content, other information can be provided. For example, for music, artist, album, genre can be provided. For games, synopsis, rating, difficulty level can be displayed. For photos, date, originating device, etc. can be depicted. After the selected content for the particular selected device is displayed on display surface 64a, the user can rearrange the content by moving it around display surface 64a, rotating it, regrouping, etc. Additionally, the user can cause that content to be transferred (moved or copied) to another device by dragging the content. For example, the user can use one finger, multiple fingers, hand, other body parts, etc. to slide the content to another device. In response to the user sliding the content to another device, computing device 20 will cause that data to be transferred (moved or copied). Additionally, the user can move the content to another device on the network so that the content will be played on the other device. In one embodiment, different gestures will be used to move, copy and play so the system knows which function to perform. For example, FIG. 8 shows hand 640 dragging Title 10 to video game 606. This will cause the video Title 10 to be moved from computer 604 to video game machine 606, or copied to video game machine 606 or played on video game machine 606, depending on the gesture.

In some embodiments, multiple content can be moved at the same time. For example, a user can point to multiple items using multiple hands and/or fingers and slide them from one device to the other. The same content can also be moved to multiple devices concurrently. For example, the user can point to one or more items using one or more hands and/or fingers and slide them from one device to the other, and, without lifting the user's hand and/or fingers, continuing to move the user's hand and/or fingers to the second device. The system would recognize that the user wants to duplicate all these items on the multiple devices.

FIG. 9 is a flow chart describing one embodiment of a process for transferring content from one device to another in response to gestures on display surface 64a. The process of FIG. 9 can be used to move or copy content to another device, or play content on another device. In step 702, computing device 20 and interactive display 60 will recognize the gesture for selecting a device. For example, a user could tap once, tap multiple times, tap with one finger, tap with multiple fingers, tap with a hand, hold with a hand, etc. No particular gesture is required. The system can be configured to recognize any particular set of one or more gestures as indicating that a device should be selected. In step 704, computing system 20 and interactive display 60 will recognize the gesture for selecting the content type. For example, one of the five buttons (music, videos, games, photos, data) can be selected with any of the gestures described above. In other embodiments, a different set of buttons can be used. In step 706, computing system 20 will send a message to the selected device (see step 702) for information about the selected content. The selected device will receive that message and search its data structure (e.g., hard disk drive) for the selected content. For example, if the user requests videos from computer 604, computer 604 will identify all the videos that it is storing and report back to computing device 20. In step 708, computing device 20 will receive information back from the selected device about the content stored on the selected device. That information could include an identification for each of the content items and other information that could be included in the icons described above. In response to receiving the information from the selected device, computing device 20 and interactive display 60 will display icons (or other items) on the display surface 64a representing each of the items of content.

Once the content items are displayed on display surface 64a, the user can use any one of the number of gestures to manipulate the icons. In step 710, computing system 20 and interactive display 60 will recognize the gesture that indicates a content should be moved, copied or played. For example, FIG. 8 shows hand 640 touching Title 10 and sliding Title 10 to video game machine 606. Other gestures can also be used. Examples of suitable gestures include (but not an exhaustive list) sliding with one finger, sliding with multiple fingers, sliding with a hand, sliding with an arm, sliding with another object, pushing, pulling, etc. In one embodiment, a first set of one or more gestures are used to move content, a second set of one or more gestures (different than the first set of one or more gestures) is used to copy content, and a third set of one or more gestures (different than the first set and second set) are used to play content. For example, one finger sliding could be used to move content, two fingers sliding can be used to copy content and an entire hand sliding can be used to play content. Other gestures can also be used. When content is moved, it is deleted from the source and stored on the destination. When content is copied, it is stored both on the source and destination.

If the gesture recognized at step 710 is to copy content (step 712), then the icon for the content is moved with the object in step 714, as depicted in FIG. 8. In step 716, computing device 20 and interactive display 60 will identify the target of the copy function. In step 718, a request is sent to the target to copy the content. In response to that request, the target machine (e.g., video game machine 606) will send a request to the source of the copy function to copy the relevant one or more files to the target. After the copy function has been completed, the target will send a confirmation message to computing device 20, which will be received in step 720. In step 722, computing device 20 and interactive display 60 will report the successful copy operation. In one embodiment, the reporting of the successful operation will be performed by removing the icon for the content being transferred from display surface 64a. In other embodiments, a pop-up window can be displayed to indicate successful transfer. If the gesture recognized in step 710 was to move content, then steps 714-722 will also be performed; however, the content will be moved rather than copied.

If the gesture recognized in step 710 was to play content (step 712), then in step 730, the icon for the content to be played is moved with the hand making the gesture, as depicted in FIG. 8. In step 732, computing device 20 and interactive display 60 will identify the target of the play operation. In step 734, computing device 20 will verify that the target device can actually play the content requested. In one embodiment, computing device 20 will include a data structure that indicates what type of content each device on the network can play, and computing device 20 will check that data structure as part of step 734 to verify that the content selected can actually be played on the target device. In another embodiment, computing device 20 will send a message to the target device requesting confirmation that the target device can play the requested content. In another embodiment, computing device 20 will send a message to the target device to indicate whether the target device includes the appropriate application for the content being requested to be played. If the target device cannot play the requested content (step 736), then an error is reported and the movement of the icon is reversed in step 742. For example, a popup window can be displayed indicating that the target device cannot play the requested content.

If the target device can play the requested content (step 736), then a request is sent to the target device to obtain a copy of the content and play that content in step 738. In response to that request from computing device 20, the target device will send a request to the source of the content to obtain a copy of the content. Upon receiving the copy, the target device will play the content. Upon the commencement of playing the content, the target device will send a confirmation to the computing device 20 in step 740. For example, looking back at FIG. 7, after the user completes dragging Title 10 to video game machine 606, video game machine 606 will obtain a copy of Title 10 from computer 604 and play the video Title 10 on its associated monitor. In one alternative, instead of copying the file for the content from the source machine to the target machine, the target machine will have the content streamed to it. In another embodiment, a separate gesture will be used by the user to indicate that the data should be streamed rather than played. Thus, there will be one gesture for playing and another gesture for streaming. When the user uses the gesture for playing, the content will be first copied to the target machine and then played from the target machine. If the user uses the gesture for streaming, then steps 730-740 will be performed; however, in step 738, computing device 20 will send a request for the target machine to stream the data and play the data. Rather than the data being copied to the target, the data will be streamed to the target machine and the target machine will play the data as it is being streamed.

A user can control any one of the devices on the network using the graphical representation of the devices on display surface 64a is to. That is, by performing gestures on display surface 64a, a user can control any of the devices on the network depicted. For example, looking back at FIG. 7, the user can perform a gesture on any of the icons 602-616 which will cause a command to be sent to the associated device for performing a function on the associated device. Examples of functions include playing content, running an application, performing a backup, running a maintenance utility, adjusting a control parameter, etc. FIG. 9 is a flow chart describing one embodiment of a process for controlling another device based on gestures performed on display surface 64a. In step 780, computing device 20 and interactive display 60 will recognize the gesture for selecting a device. Any of the gestures discussed above can be pre-configured for indicating a selection of a device. In step 782, computing system 20 and interactive display 60 will recognize the gesture for a command to be performed on the selected device. Any of the gestures described above can be pre-configured to indicate any of various commands that can be performed on a device. In step 784, a message is sent from computing device 20 to the selected device. That message will indicate the command requested to be performed. In response to receiving that message, the selected device will perform the command (or not perform the command). In step 786, the selected device will send a confirmation to computing device 20. In step 788, computing device 20 and interactive display 60 will cause the confirmation to be displayed on display surface 64a. For example, a popup window can indicate that the command has been performed (or not performed).

A user can also use gestures on display surface 64a to create and manage data relationships between devices on the network. Examples of relationships include (but are not limited to) one way synchronization, two way synchronization and backups. These data relationships can include repeated transfer of data (e.g., synchronization or backup) based on a set of one or more rules configured by the user. The rules can indicate when and how, and what data, to synchronize or backup.

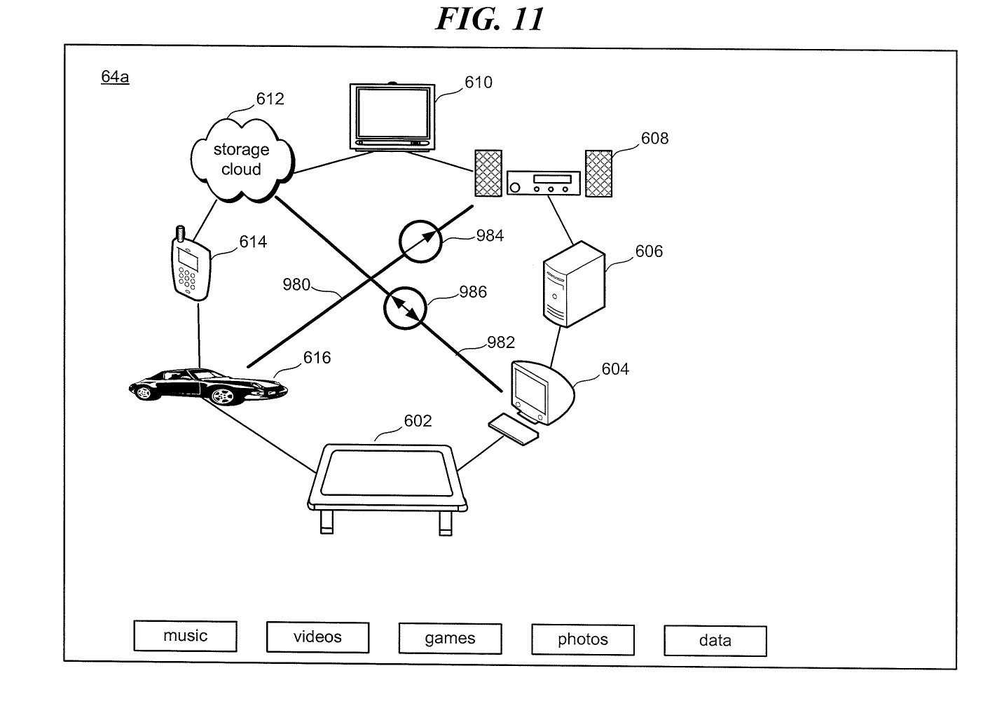

FIG. 11 shows devices 602-616 that are on the network. Relationships are shown by lines 980 and 982. Line 980 shows the relationship between automobile 616 and stereo system 608. Line 982 shows the relationship between computer 604 and storage cloud 612. Each relationship line includes a relationship graphic which indicates the type of relationship. For example, line 980 includes relationship graphic 984 and relationship line 982 includes relationship graphic 986. Relationship graphic 984 is a uni-directional arrow indicating one way synchronization. Therefore, data from automobile 616 is synchronized to stereo 608 so that all data stored on automobile 616 is also stored on stereo 984. Relationship graphic 986 is a bi-directional arrow which indicates that there two way synchronization between computer 604 and storage cloud 612. Therefore, all data stored on computer 604 is also stored on storage cloud 612 and all data stored on storage cloud 612 is also stored on computer 604. If two devices have a backup relationship, then a relationship graphic (e.g., circle with a B and an arrow inside) can be used to indicate that all data from one device will be periodically backed up to the other device. In one embodiment, a gesture can be used to configure the relationship. For example, a user can hold a fist down on the relationship graphic to cause a popup window to be displayed. The user can enter data inside the popup window to manage a relationship. For example, the user can indicate how often a backup or synchronization should be performed, folders that should be backed up, what to do if there is a conflict, what to do if there is an error, etc. When a relationship is created, computing device 20 and interactive display 60 will create and display the appropriate relationship line and relationship graphic. The relationship can be ended (or cancelled) by another gesture. For example, a user can draw an X or a line through a relationship graphic or relationship line. The system will recognize that gesture and end the relationship.

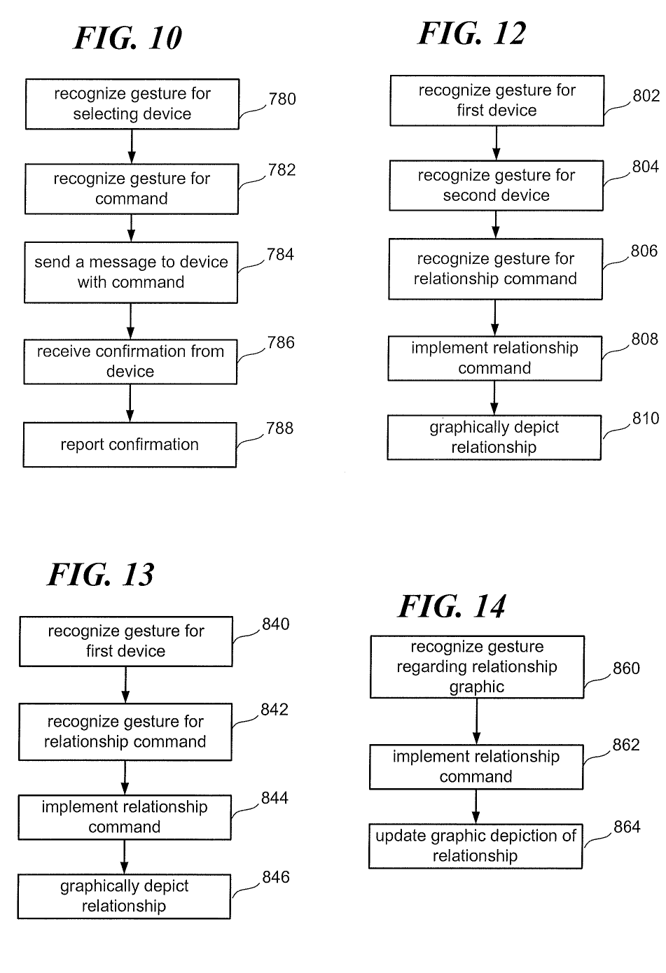

FIG. 12 is a flow chart describing one embodiment for creating relationships. In step 802, computer device 20 and interactive display 60 will recognize a gesture for selecting a first device. Any of the gestures discussed above for selecting can be used. In step 804, computer device 20 and interactive display 60 will recognize a gesture for selecting a second device, as discussed above. In step 806, computer device 20 and interactive display 60 will recognize the gesture for indicating the type of relationship to be created. In one embodiment, the system will be configured to match various gestures with various relationship commands. In step 808, computing device 20 will implement the relationship based on the command received by the gesture recognized in step 806. For example, if a backup system is to be created, computing device 20 will send the appropriate commands to the appropriate devices to create the backup. For example, backup software can be configured to perform the requested backup. Similarly, if a synchronization is requested, software for performing synchronization will be configured in step 808. In step 810, computing device 20 and interactive display 60 will graphically display the relationship (e.g., as depicted in FIG. 10).

FIG. 13 is a flow chart describing another embodiment of creating a relationship. In step 840, computing device 20 and interactive display 60 will recognize a gesture for selecting a first device, as discussed above. In step 842, computing device 20 and interactive display 60 will recognize the gesture for the command to establish the relationship. This gesture will both indicate the relationship and the second device. For example, if the user places two hands (one on each device) the system will recognize that to be a request to set up a backup. Alternatively, one finger on each device can be used to indicate one way synchronization and two fingers on each device can be used to represent two way synchronization. In step 844, computing device 20 will implement the request for the relationship to be created (similar to step 808). In step 846, the relationship will be graphically depicted on display surface 64a.

FIG. 14 is a flow chart describing one embodiment of a process of managing an established relationship. In step 860, computing device 20 and interactive display 60 will recognize a gesture indicating a request to configure an existing relationship. That gesture may be an X or a slash drawn on display surface 64a to indicate that the relationship should be terminated. Alternatively, a fist on the relationship graphic (or other gesture) can be used to request a menu of choices for configuring the relationship. In step 862, the command is implemented, as discussed above. In step 864, the relationship is updated based on the configuration performed in step 862.

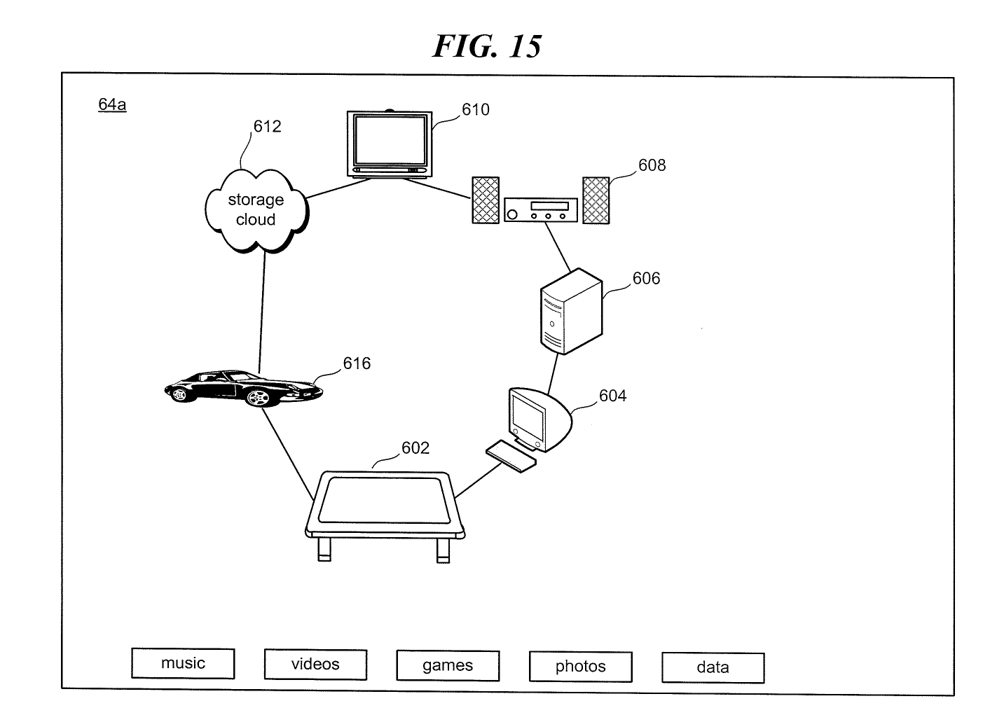

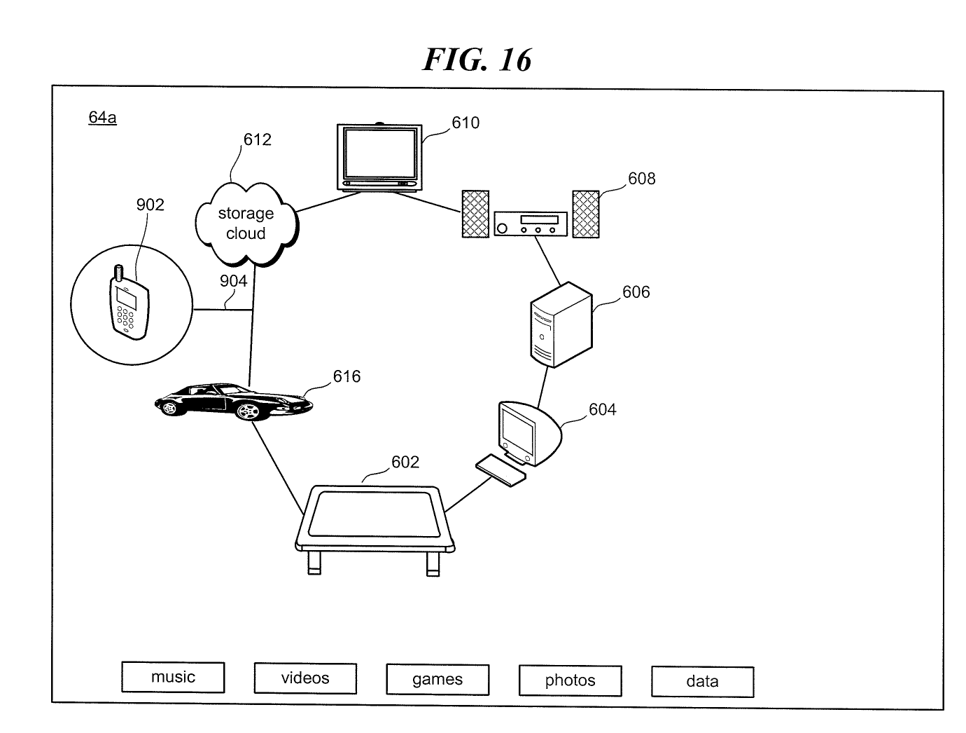

In FIGS. 5 and 7, a cellular telephone 514/614 was directly connected to network 500. In another embodiment, a cellular telephone (or other device) can communicate with other devices on network 500 via computing device 20. Consider the example where the devices connected to the network include computing device 20 (with interactive display 60), computer 504, video game machine 506, stereo 508, television system 510, storage cloud 512 and automobile 516. In that case, the graphic summary of the network will be displayed on surface 64a as depicted in FIG. 15, which shows icon 602, icon 604, icon 606, icon 608, icon 610, icon 612 and icon 616. Icon 614 is not depicted because cellular telephone 514 is not connected to network 500. A user can provide for cellular telephone 514 (or other device) to communicate with the network devices (20, 504, 506, 508, 510, 512 and 526) by placing the cellular telephone 514 (or other device) on top of display surface 64a. Computing device 20 and interactive display 60 will recognize cellular telephone 514 being placed on surface 64a, create a connection between computing device 20 and cellular telephone 514, allow cellular telephone 514 to communicate with other entities on the network via computing device 20 and graphically depict on display surface 64a that cellular telephone 514 is now in communication with the network. FIG. 16 shows display surface 64a graphically depicting that cellular telephone 514 is able to communicate with devices on the network. Display surface 64a shows icon 902 indicating cellular telephone 514. A circle is drawn around icon 902 to indicate that the cellular telephone is on surface 64a. Line 904 from the circle around icon 902 indicates communication with devices on the network.

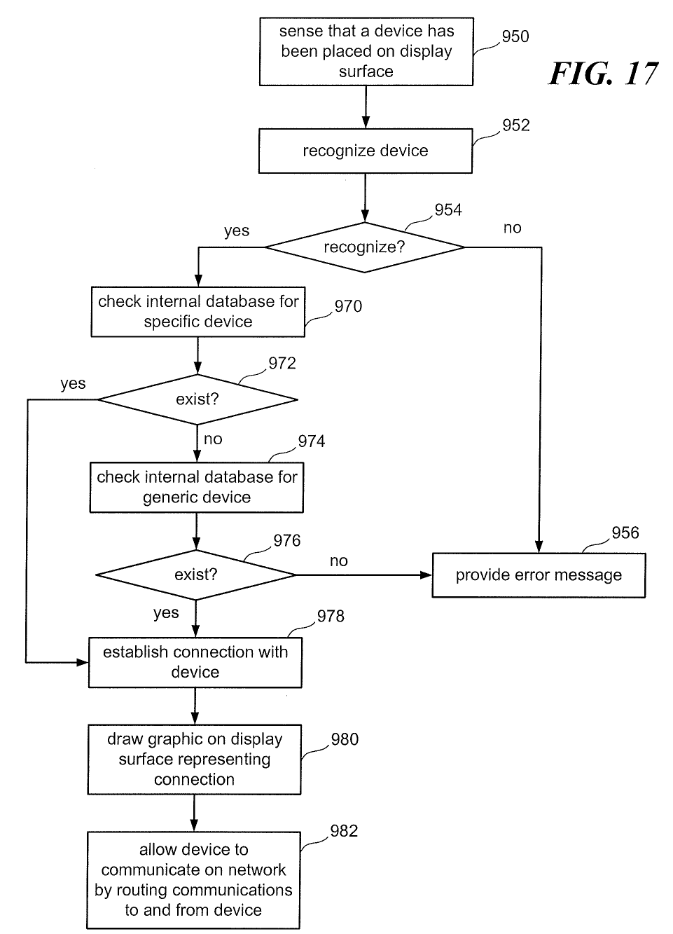

FIG. 17 is a flow chart describing one embodiment of a process for connecting a device to the network by placing the device on display surface 64a. In one embodiment, the process of FIG. 17 is performed automatically. In step 950, computing device 20 and interactive display 60 senses that a device has been placed on display surface 64a. In step 952, computing device 20 and interactive display 60 recognize the device. There are many means for recognizing a device. In one embodiment, the system recognizes the shape of the device. In another embodiment, the system recognizes a tag, symbol (e.g., UPC symbol) or other marking on the device. In another embodiment, the device wirelessly transmits an identification (e.g., using Bluetooth, infrared, etc.). If the system does not recognize the device (step 954), then an error message is provided on display surface 64a (step 956). In one embodiment, computing device 20 includes a data structure which lists all the devices it knows about and indicia for recognizing the device. Computing device 20 will use this data structure to perform step 952.

If, in step 952, the device is recognized (step 954), then in step 970, computing device 20 will check another internal database to see whether that specific device is listed. Computing device 20 will include a database for each device it knows about that indicates how to communicate with that device. If the database does not have a record for that specific device (step 972), then computing device 20 will check the same (or different) data structure for a record for the generic type of device in step 934. For example, if the user put a particular type of cellular telephone on display surface 64a, computing device 20 will first see whether there is a record in the database for that specific user's cellular telephone. If not, computing device 20 will look for a record for the make and model of cellular telephone. If there is no record for a generic device (step 976), then an error message is provided at step 956.

If computing device 20 does find the record for the specific device or generic device, then in step 978 computing device 20 will establish a connection with the device. There are many means for establishing a connection. For example, a connection can be established using Bluetooth, infrared, RF, or any cellular technology. Other communication technologies can also be used. In one embodiment, the connection made in step 978 will be used for all subsequent communication. In another embodiment, the connection made in step 978 is used to create an initial connection and that initial connection is then used to configure the device placed on top of display surface 64a to perform communication via a different means. For example, the initial connection can be over the cellular network and used to configure WiFi so that computing device 20 and the device placed on display surface 64a can communicate via protocols of IEEE 802.11a/b/g or other wireless protocols.

In one embodiment, computing device 20 database will include an identification of the particular device and identification of a service provider for that device. Computing device 20 can contact the service provider for information on how to communicate with the device or computing device 20 can establish a connection to the device via the service provider. For example, if the device placed on the display surface 64a is a cellular telephone, computing device 20 can contact the cellular service provider for that telephone and learn how to contact the cell phone via the service provider.

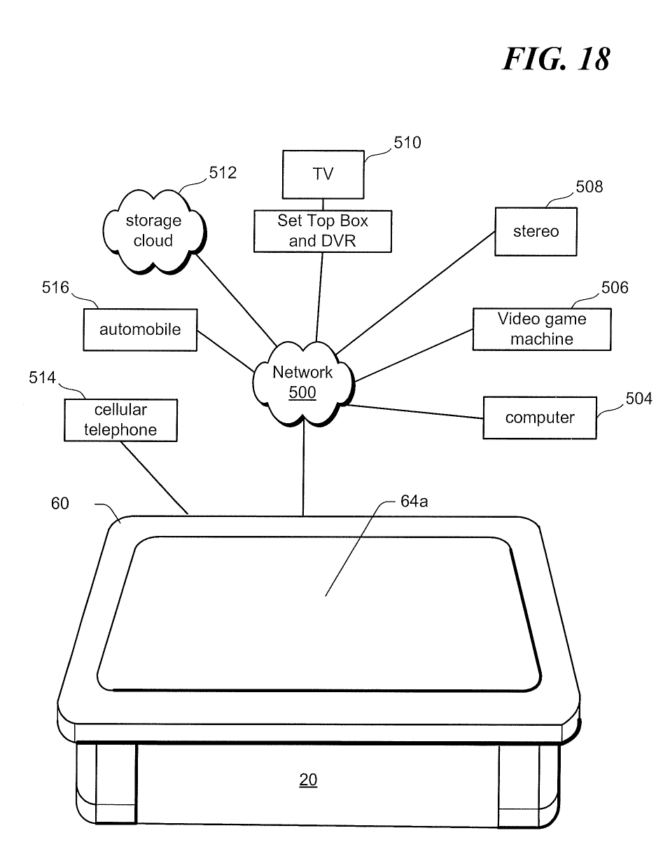

After establishing the connection in step 978, computing device 20 and interactive display 60 will draw the graphic on display surface 64a representing the connection. For example, looking back at FIG. 16, icon 902, the circle around icon 902 and line 904 will be displayed in step 980. In step 982, computing device 20 and interactive display 60 will provide for the newly connected device to communicate on the network by routing communications to and from the device. FIG. 18 is a block diagram symbolically showing the physical connection of the devices on network 500. As can be seen, computing device 20, computer 504, video game machine 506, stereo 508, television system 510, storage cloud 512 and automobile 516 communicate directly on network 500. On the other hand, cellular telephone 514 is connected to computing device 20 and communicates on network 500 through computing device 20. Thus, communication from cellular telephone 514 to another device on the network will first be communicated from cellular telephone 514 to computing device 20 and then from computing device 20 to the other device on the network. Similarly, communications for cellular telephone 514 will first be communicated to computing device 20 and then from computing device 20 to cellular telephone 514.

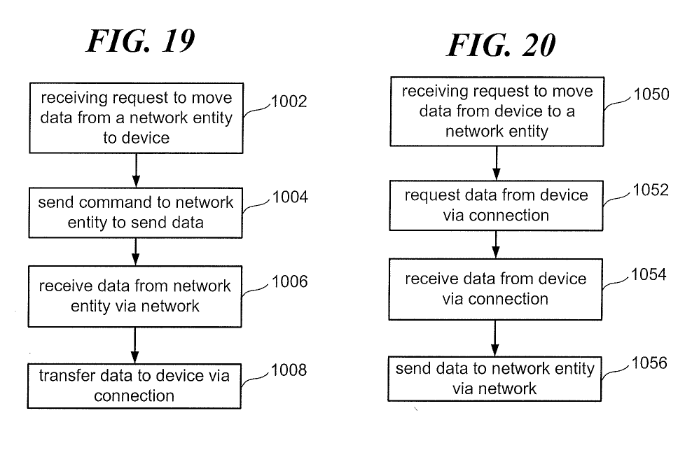

FIG. 19 is a flow chart describing one embodiment of a process for sending data or a message to cellular telephone 514. In step 1002, computing device 20 will receive a request to move data from a network entity to the device on display surface 64a. For example, a user interacting with display surface 64a (as depicted in FIG. 16) may request that data be moved from stereo 608 to cellular telephone 514 represented by icon 902. This can be accomplished by the user performing a set of gestures as discussed above. In response, computing device 20 will send a command to the network entity that is the source of the data transfer in step 1004. That command will request the network entity to send the data to computing device 20. In response to that command, that network entity will send the data to computing device 20. In step 1006, computing device 20 will receive the data from the network entity via network 500. In step 1008, computing device 20 will transfer that data received to cellular telephone 514 represented by icon 902. That data is transferred via the connection established by step 978 of FIG. 17.

FIG. 20 is a flow chart describing one embodiment of a process for moving data from the entity on display surface 64a to another entity on the network. In step 1050, a request to move data from that device to the network entity is received by computing device 20 and interactive display 60. For example, gestures are used, as discussed above, to request that data be moved from cellular telephone 514 (icon 902) to computer 504 (icon 604). In step 1052, computing device 20 will request the data from cellular telephone 514 (icon 902) via the connection established in step 978 of FIG. 17. That data will be received at computing device 20 in step 1054. The received data will be sent to the network entity in step 1056 via network 500.

On some embodiments, display surface 64a can present areas or icons that are beyond an actual device or network location, but are logical entities. For example, display surface 64a can include an area titled “playlist” that a user can drag content to from all devices. The playlist will actually be a collection of pointers to files. A user can rearrange items in the playlist to define the order they will be played. A user can make a gesture too “play” the playlist on a specific device and the device will play the files from the different locations they reside on (or copy and play if it cannot stream). A user can also have multiple playlists so, for example, the user you have a photo playlist that is sent to the TV and a music playlist that is sent to the stereo. Links between these playlists can be created. For example, a folder of photos can be linked to a song so that when the stereo gets to the that song certain photos will be played (or the other way around).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for controlling a device on a network, comprising:
displaying, on a display surface of a first device, images representing a set of devices that can communicate on a network;
automatically sensing an object adjacent to the display surface;
automatically determining that a first type of gesture of a plurality of types of gestures is being performed by the object adjacent to the surface;
identifying a command associated with the first type of gesture; and
generating a communication and sending the communication from the first device to a target device via the network to cause the target device to perform the command in response to determining that the first type of gesture is being performed, the target device is different than the first device, the set of devices that can communicate on the network includes the target device.

2. The method of claim 1, further comprising:
automatically determining that a second type of gesture of the plurality of types of gestures is being performed by the object on the surface; and
determining that the second type of gesture indicates a selection of the target device.

3. The method of claim 1, wherein:
the first type of gesture includes the presence of the object over an image on the display surface corresponding to the target device.

4. The method of claim 1, wherein:
each of the plurality of types of gestures is associated with a different command that can be performed on more than one of the devices that can communicate on the network; and
the method further comprises automatically determining other type of gestures of a plurality of types of gestures are being performed at different times by the object and sending additional communications to different devices via the network to cause the different devices to perform different commands.

5. The method of claim 1, wherein:
the generating a communication includes generating a communication that requests that the target device to play content stored on another device.

6. The method of claim 1, further comprising:
automatically identifying a selection gesture by the object that selects a source device, the set of devices that can communicate on the network includes the source device, the generating a communication includes generating a communication that requests that the target device play content stored on the source device, the source device is different than the target device.

7. The method of claim 6, further comprising:
automatically determining that the target device is selected for the command based on sensed movement of the object.

8. The method of claim 7, wherein:
set of devices that can communicate on the network includes the first device;
the object is a human hand;
the first type of gesture includes the presence of the object over an image on the display surface corresponding to the target device;
each of the plurality of types of gestures is associated with a different command that can be performed on more than one of the devices that can communicate on the network; and
the method further comprises automatically determining other type of gestures of a plurality of types of gestures are being performed at different times by the object on the surface and sending additional communications to different devices via the network to cause the different devices to perform different commands.

9. The method of claim 1, further comprising:
automatically identifying a selection gesture by the object that selects a source device, the set of devices that can communicate on the network includes the source device, the generating a communication includes generating a communication that requests that the target device play content streamed from the source device, the source device is different than the target device; and
automatically determining that the target device is selected for the command based on sensed movement of the object.

10. The method of claim 1, wherein:
the object is a human hand.

11. A method for controlling a device on a network, comprising:
displaying, on a display surface of a first device, images representing a set of networked devices that can communicate on a network;
automatically sensing an object adjacent to the display surface;
automatically determining that a first type of gesture of a plurality of types of gestures is being performed by the object adjacent to the surface;
identifying a command associated with the first type of gesture; and
generating a communication and sending the communication from the first device to at least one of a set of selected devices via the network, the communication includes information to cause the selected devices to implement a data relationship that includes repeated transfer of data based on a set of one or more rules associated with the data relationship.

12. The method of claim 11, further comprising:
automatically identifying a gesture by the object above an image of a first device on the display surface that selects the first device, the set of selected devices includes the first device; and
automatically identifying a gesture by the object above an image of a second device on the display surface that selects the second device of the set of selected devices, the set of selected devices includes the second device.

13. The method of claim 11, further comprising:
graphically depicting the data relationship on the display surface using a first image on the display surface.

14. The method of claim 13, further comprising:
automatically identifying a particular gesture by the object at or near the first image;
providing configuration options in response to identifying the particular gesture;
receiving configuration information; and
configuring the data relationship based on the configuration information.

15. The method according to claim 11, wherein:
the communication includes information to cause the selected devices to implement synchronization between the selected devices.

16. The method according to claim 11, wherein:
the communication includes information to cause the selected devices to implement backup process.

17. An apparatus for providing communication on a network, comprising:
one or more processors;
one or more storage devices in communication with the one or more processors;
a network interface in communication with the one or more processors;
a display surface in communication with the one or more processors; and
a sensor in communication with the one or more processors, the sensor senses data indicating presence of a communication device on the display surface that is not directly connected to the network;
the one or more processors recognize the communication device on the display surface that is not directly connected to the network, determine how to communicate with the communication device on the display surface and relay data between the communication device on the display surface that is not directly connected to the network and at least one other device on the network.

18. The apparatus of claim 17, wherein:
the one or more processors relay the data by communicating with the communication device without using the network and communicating with the at least one other device on the network using the network.

19. The apparatus of claim 17, wherein:
the sensor senses a gesture by an object adjacent to the display surface;
the one or more processors recognizes the gesture and identify a function to be performed; and
the one or more processors cause the function to be performed with respect to the communication device and another device on the network.

20. The apparatus of claim 17, wherein:
the sensor senses different gestures by a body adjacent to the display surface;
the one or more processors recognize the different gestures from a set of possible gestures;
the one or more processors identify different functions to be performed for the different gestures; and
the one or more processors causes the different functions to be performed with respect to the communication device and at least one other device on the network.
